(19) United States
(12) Patent Application Publication
(10) Pub. No.: US 2012/0247156 A1
(43) Pub. Date: Oct. 4, 2012

(54) Method of producing biosoluble inorganic fiber

(75) Inventors: Hideki Kitahara, Tokyo (JP); Takahito Mochida, Tokyo (JP); Takashi Nakajima, Tokyo (JP); Tetsuya Mihara, Tokyo (JP); Ken Yonaiyama, Tokyo (JP); Noboru Kobayashi, Tokyo (JP); Ikuo Abe, Tokyo (JP); Hideo Nagase, Tokyo (JP)

(73) Assignee: Nichias Corporation, Tokyo (JP)

(21) Appl. No.: 13/064,640

(22) Filed: Apr. 5, 2011

(30) Foreign Application Priority Data
Mar. 31, 2011 (JP) 2011-077940

(51) Int. Cl. C03B 37/05; C03B 37/07; C03B 37/06

(52) U.S. Cl. 65/377; 65/455

(57) ABSTRACT

A method of producing inorganic fibers includes heating and melting an inorganic raw material that includes 70 wt % or more of silica and 10 wt % to 30 wt % of magnesia and calcia in total in a container to obtain a melt having a melt viscosity of 15 poise or less, supplying the melt to a rotor that rotates at an acceleration of 70 km/s² or more, drawing the melt due to a centrifugal force caused by rotation of the rotor to obtain fibers, blowing the fibers off by blowing air around the rotor, and collecting the fibers to obtain fibers having an average fiber diameter of 5 μm or less.

### TECHNICAL FIELD

The invention relates to a method of producing biosoluble inorganic fibers.

### BACKGROUND

Inorganic fibers are lightweight, have a good handling capability, and exhibit excellent heat resistance. Therefore, inorganic fibers are used as a heat-resistant seal material, for example. In recent years, it has been pointed out that health problems may occur due to inhalation of inorganic fibers into to a lung of a living body. Therefore, biosoluble inorganic fibers that do not cause (or rarely cause) health problems upon inhalation have been developed (see Japanese Patent No. 3753416 and JP-T-2005-514318, for example).

JP-A-2010-202983 and JP-A-2010-189798 disclose producing inorganic fibers having an average fiber diameter of 100 to 2000 nm or 3 to 50 μm by an electrospinning method. JP-A-2003-105658 discloses producing inorganic fibers having an average fiber diameter of 4 to 10 μm and containing alumina as the main component by a blowing method that produces fibers by applying compressed air to a raw material melt.

JP-A-63-239135, JP-A-63-230535, JP-T-06-504257, and Japanese Patent No. 3260367 disclose an air spinning method that supplies a raw material melt to a rotor, and produces fibers by utilizing the centrifugal force of the rotor and air jetted from the periphery of the rotor. JP-T-06-504257 and Japanese Patent No. 3260367 disclose that fibers having excellent properties are obtained by producing rock wool having an SiO₂ content of less than 70% at a high centrifugal acceleration. JP-A-63-239135 discloses a method that controls the fiber diameter with the viscosity of a melt and the centrifugal acceleration. JP-A-63-230535 discloses the velocity of the first rotor.

### SUMMARY OF THE INVENTION

Biosoluble inorganic fibers contain silica (SiO₂) as the main component, and also contain calcia (CaO), magnesia (MgO), and the like. Since the fire resistance of the fibers increases as the silica content in the fibers increases, fibers having a high silica content have been developed. However, if the raw material has a silica content of 70 wt % or more, it is difficult to obtain fibers having a small fiber diameter (diameter) due to an increase in viscosity of the raw material. Therefore, biosoluble fibers currently on the market have a diameter of 4.5 μm or more. It has been very difficult to stably produce fibers having a diameter of several μm and having a low shot content at a high temperature of about 2000° C.

An object of the invention is to provide a method that can industrially and stably produce biosoluble inorganic fibers having a small diameter which it is impossible or difficult to produce by a known method due to high viscosity, or from the raw material of which only fibers with a large diameter can be produced by the known method.

The inventors of the invention conducted extensive studies in order to achieve the above object, and found that the diameter of fibers including 70 wt % or more of silica can be reduced while reducing the shot content under specific production conditions. This finding has led to the completion of the invention.

The invention provides the following production method.

1. A method of producing inorganic fibers including heating and melting an inorganic raw material that includes about 70 wt % or more of silica and about 10 wt % to about 30 wt % of magnesia and calcia in total in a container to obtain a melt having a melt viscosity of about 15 poise or less, supplying the melt to a rotor that rotates at an acceleration of about 70 km/s² or more, drawing (stretching) the melt due to a centrifugal force caused by rotation of the rotor to obtain fibers, blowing the fibers off by blowing air around the rotor, and collecting the fibers to obtain fibers having an average fiber diameter of about 5 μm or less.
2. The method according to 1, wherein the acceleration is about 100 km/s² or more.
3. The method according to 1 or 2, wherein the melt has a melt viscosity of about 4 poise or less, and is supplied to the rotor that rotates at an acceleration of about 115 km/s² or more.
4. The method according to 1 or 2, wherein the melt has a melt viscosity of about 7 poise or less, and is supplied to the rotor that rotates at an acceleration of about 259 km/s² or more.
5. The method according to 1 or 2, wherein the melt viscosity of the melt and the acceleration of the rotor satisfy the following expressions,

A≧36.81×P−11.21

15≧P

where, P is the melt viscosity (poise) of the melt, and A is the acceleration (km/s²) of the rotor.
6. The method according to any one of 1 to 5, wherein the inorganic raw material is melted by applying about 0.15 kW/kg to about 0.70 kW/kg of electric power per unit raw material.
7. The method according to 6, wherein the inorganic raw material is melted by applying about 0.25 kW/kg to about 0.70 kW/kg of electric power per unit raw material.
8. The method according to any one of 1 to 7, wherein the container has a hole for supplying the melt to the rotor at its bottom, a rod is provided inside the container toward the hole, and the amount of the melt supplied to the rotor is adjusted by bringing the rod close to the hole when the hole has increased in diameter.
9. The method according to any one of 1 to 8, wherein the inorganic raw material is heated at about 1600° C. to about 2500° C.
10. The method according to anyone of 1 to 9, wherein the melt is supplied to the rotor at a speed of about 100 kg/h to about 1000 kg/h.
11. The method according to 10, wherein the melt is supplied to the rotor at a speed of about 250 kg/h to about 800 kg/h.
12. The method according to any one of 1 to 11, wherein the fibers have an average fiber diameter of about 2 μm to about 4.4 μm.
13. The method according to any one of 1 to 12, wherein the fibers comprise shots having a dimension of about 45 μm or more in an amount of about 65 wt % or less.
14. The method according to any one of 1 to 13, wherein the fibers have the following composition 1 or 2,

### <Composition 1>

SiO₂: about 70 wt % to about 82 wt %
CaO: about 1 wt % to about 9 wt %
MgO: about 10 wt % to about 29 wt %
Al₂O₃: less than about 3 wt %

### <Composition 2>

SiO₂: about 70 wt % to about 82 wt %
CaO: about 10 wt % to about 29 wt %
MgO: about 1 wt % or less
Al₂O₃: less than about 3 wt %.

The invention makes it possible to stably produce biosoluble inorganic fibers having a small diameter.

### BRIEF DESCRIPTION OF THE DRAWINGS

FIG. 1 is a view illustrating an example of an apparatus that may be used for a production method according to the invention.

FIG. 2 is a view illustrating the relationship between the melt viscosity of fibers that differ in composition and the temperature.

FIG. 3 is a view illustrating the relationship between the melt viscosity and the fiber diameter of fibers that differ in composition.

FIG. 4 is a view illustrating the relationship between the presence or absence of a rod and a change in the amount of a melt supplied with time.

### DETAILED DESCRIPTION OF THE PREFERRED EMBODIMENTS

The invention aims at producing inorganic fibers (silica-alkaline-earth-metal fibers) that include 70 wt % or more of silica and 10 to 30 wt % of magnesia and calcia in total. Such fibers are known as biosoluble fibers.

The silica-alkaline-earth-metal fibers are used for various applications (e.g., heat insulator). It is desirable that the silica-alkaline-earth-metal fibers have an average diameter of about 5 μm or less.

Even if the silica-alkaline-earth-metal fibers with a small fiber diameter are inhaled into a human body, the fibers are easily dissolved in the body. Moreover, the silica-alkaline-earth-metal fibers have a smooth texture (are not scratchy). If the fibers have a small average diameter, the number of fibers per unit volume of the product increases. Therefore, the heat insulation effect is improved due to a decrease in thermal conductivity. Moreover, a dense product is obtained, so that the heat insulation effect is improved. The tensile strength also increases as the number of fibers increases. A number of advantages are thus obtained by a small fiber diameter.

However, not too small fiber diameter is required for molding. In JP-A-2010-202983, fibers with a nanometer level diameter are obtained by electrostatic spinning. The invention does not aim at producing such fibers. The diameter of the inorganic fibers produced by the method according to the invention is preferably 2 μm or more.

A blowing method and a spinning method are known as a fiber production method. Silica-alkaline-earth-metal fibers produced by the blowing method tend to have a high shot content. Therefore, the method according to the invention utilizes the spinning method. The spinning method includes supplying a melt of a raw material to a rotating rotor, and drawing the melt by utilizing the centrifugal force of the rotor and air jetted from the periphery of the rotor to produce fibers.

The raw material must be melted at a very high temperature when producing small diameter fibers that include 70 wt % or more of silica using the spinning method. Therefore, it is necessary to employ conditions that achieve a high temperature, and stably supply the melt to the rotor without damage due to a high temperature. If the melt is not stably supplied, the melt comes in contact with the rotor in an unstable state, and, as a result, the properties of the fibers produced may deteriorate. The invention achieves high-temperature melting and stable supply by combining a plurality of conditions, and thus makes it possible to industrially produce thin silica-alkaline-earth-metal fibers that exhibit good quality and have an average diameter of about 5 μm or less. The average diameter is determined by the method described in the examples.

The resulting fibers normally have a content of shots having a dimension of 45 μm or more of 65% or less (e.g., 30 to 55%). The shot content is determined by the method described in the examples.

A production method according to one embodiment of the invention is described in detail below with reference to the drawings.

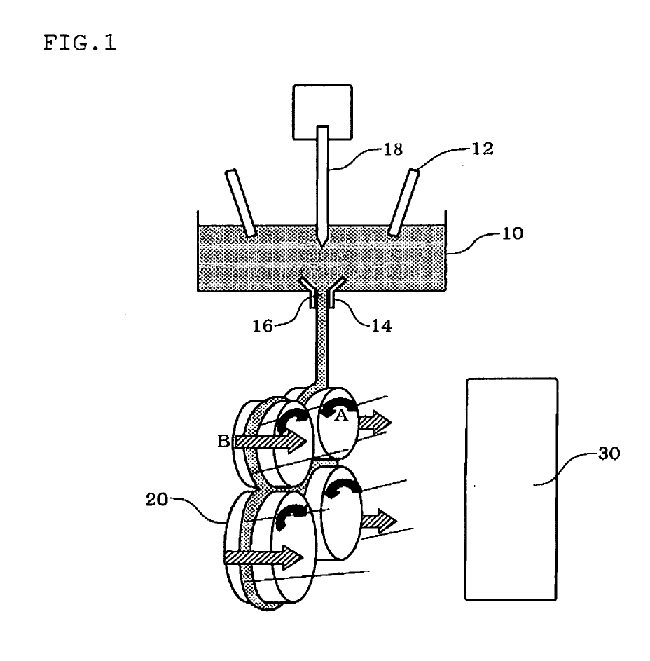

FIG. 1 illustrates an example of an apparatus that may be used for the production method according to the embodiment.

Raw materials (e.g., silica sand, magnesium oxide, magnesium carbonate, wollastonite, calcium carbonate, strontium carbonate, kaolin, and alumina) are melted in a container 10 to obtain a melt having a low melt viscosity of 15 poise or less (preferably 10 poise or less, 7 poise or less, 5 poise or less, or 4 poise or less). The lower limit of the melt viscosity is 1 poise or more from the viewpoint of ease of implementation. The heating temperature is not limited insofar as a given viscosity is achieved, but is normally about 1600 to about 2400° C., and particularly about 1700 to about 2400° C. All the raw materials are preferably melted by the above operation.

One or two or more electrodes 12 are provided in the container 10, and the raw material is melted by heating via the electrodes. The electrodes 12 may be formed of a heat-resistant material (e.g., molybdenum). It is preferable that the container 10 be formed of boiler steel, and have a cooling unit.

The electric power applied to the electrodes 12 is preferably 0.15 to 0.70 kW/kg, and more preferably 0.25 to 0.70 kW/kg.

An orifice 14 that allows the melt to flow toward a rotor 20 is formed at the bottom of the container 10. The orifice has a funnel-shaped hole 16. The amount of the melt that flows toward the rotor 20 is adjusted by adjusting the diameter and the length of the hole of the orifice. The amount of the melt that flows toward the rotor 20 increases as the diameter of the hole increases and the length of the hole decreases. The wall of the orifice is damaged when the high-temperature melt continuously flows through the hole, and, as a result, the diameter of the hole increases. The amount of the melt that flows toward the rotor 20 increases (i.e., an unstable state occurs) as the diameter of the hole increases. In the apparatus shown in FIG. 1, a rod 18 is vertically provided inside the container 10 toward the hole 16. The end of the rod preferably has a shape corresponding to the shape of the hole. In the apparatus shown in FIG. 1, the rod has a sharp end. It is preferable to lower the control rod when the diameter of the hole has increased in order to allow a constant amount of the melt to be supplied to the rotor.

The melt is supplied to the rotating rotor 20 via the orifice 14. The melt is supplied at a speed of 100 to 1000 kg/h, for example, and preferably 250 to 800 kg/h.

Two or more rotors (preferably 2 to 4 rotors) are used so that the opposing rotors rotate clockwise and counterclockwise in the inward direction indicated by arrows A. The melt is supplied to the outer circumferential surfaces of one rotor. The melt then flows over the outer circumferential surface of each rotor.

The melt is drawn due to the centrifugal force caused by rotation of the rotor 20 to obtain fibers. In the embodiment, the acceleration of the rotor is 70 km/s² or more. It is preferable that the acceleration of each rotor be 70 km/s² or more. The acceleration is preferably 100 km/s² or more, more preferably 150 km/s² or more, and still more preferably 250 km/s² or more. The upper limit of the acceleration is 550 km/s² or less from the viewpoint of ease of implementation.

The viscosity and the acceleration are combined within the melt viscosity range and the acceleration range mentioned above, whereby fibers having a small diameter can be obtained.

For example, the melt viscosity is adjusted to 4 poise or less, and the acceleration is adjusted to 115 km/s² or more, or the melt viscosity is adjusted to 7 poise or less, and the acceleration is adjusted to 259 km/s² or more.

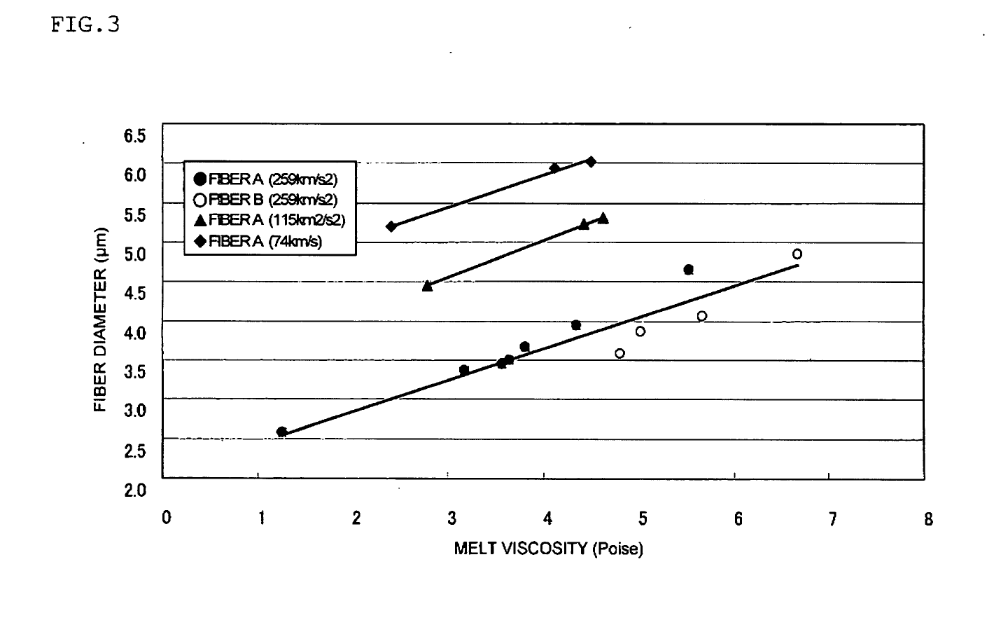

Data shown in FIG. 3 indicates that the fiber diameter, the viscosity, and the acceleration satisfy the following relationship.

D=−1.16×10⁻²×A+4.27×10⁻¹×P+4.87

where, D is the fiber diameter (μm), P is the melt viscosity (poise) of the melt, and A is the acceleration (km/s²) of the rotor.

Therefore, when the melt viscosity and the acceleration satisfy the following expressions, fibers having a diameter of 5 μm or less are obtained.

A≧36.81×P−11.21

15≧P

where, P is the melt viscosity (poise) of the melt, and A is the acceleration (km/s²) of the rotor.

The melt viscosity P (poise) of the melt is more than 0, preferably 0.5 or more, and more preferably 1 or more.

Stripping air is blown around the rotors 20 in the direction of a collector 30 indicated by arrows B. Stripping air nozzles (outlet) are preferably provided near the rotors. The distance between the stripping air nozzles and the rotors is preferably 0 to 300 mm. The stripping air nozzles may be provided on the rotors, or may be provided at a position away from the rotors.

The fibers blown off due to stripping air are collected by the collector 30 to obtain collective inorganic fibers.

The silica-alkaline-earth-metal fibers produced by the method according to the invention include 70 wt % or more of silica, and 10 to 30 wt % of magnesia and calcia in total. If the silica content is 70 wt % or more, excellent heat resistance is obtained. If the total content of magnesia and calcia is 10 to 30 wt %, excellent biosolubility is obtained.

The silica content is preferably 70 to 80 wt %, and more preferably 71 to 79 wt %.

The total content of magnesia and calcia is preferably 15 to 28 wt %, and more preferably 19 to 28 wt %.

The fibers may further include Al₂O₃ (e.g., 5 wt % or less) K₂O, Na₂O, Fe₂O₃, ZrO₂, P₂O₄, B₃O₃, La₂O₃, and the like.

If the Al₂O₃ content is 1 to 4 wt %, the fibers have proper water solubility and the processing thereof is facilitated without impairing the quality. The Al₂O₃ content is preferably 1 to 3 wt %.

The total content of SiO₂, CaO, MgO, and Al₂O₃ may be more than 95 wt %, or more than 97 wt %, or more than 98 wt %.

Such fibers may be roughly divided into Mg silicate fibers having a high MgO content, and Ca silicate fibers having a high CaO content. The Mg silicate fibers may have the following composition.

SiO₂: 70 to 82 wt % (preferably 70 to 80 wt %, and more preferably 71 to 79 wt %)
CaO: 1 to 9 wt % (preferably 2 to 8 wt %)
MgO: 10 to 29 wt % (preferably 10 to 25 wt %)
Al₂O₃: less than 3 wt % (preferably less than 2 wt %)
Other oxides: less than 2 wt % (preferably less than 1 wt %)

The Ca silicate fibers may have the following composition. Such fibers are preferable from the viewpoint of heat resistance and biosolubility. The Ca silicate fibers tend to have a low melt viscosity at a low temperature (i.e., the fiber diameter can be more easily reduced) as compared with the Mg silicate fibers.

SiO₂: 70 to 82 wt % (preferably 70 to 80 wt %, and more preferably 72 to 78 wt %)
CaO: 10 to 29 wt % (preferably 20 to 29 wt %, and more preferably 21 to 28 wt %)
MgO: 1 wt % or less
Al₂O₃: less than 3 wt % (preferably 1 to 2 wt %)
Other oxides: less than 2 wt % (preferably less than 1 wt %)

The above inorganic fibers may or may not include K₂O, Na₂O, Fe₂O₃, ZrO₂, P₂O₄, B₂O₃, and La₂O₃ as other oxides.

The total content of SiO₂, CaO, MgO, and Al₂O₃ may be more than 98 wt %, or more than 99 wt %.

When the fibers include Fe₂O₃, the total content of SiO₂, CaO, MgO, Al₂O₃, and Fe₂O₃ may be more than 98 wt %, or more than 99 wt %.

The above fibers having the above composition exhibit excellent biosolubility, and exhibit an increase in biosolubility after heating.

### EXAMPLES

### Experiment 1

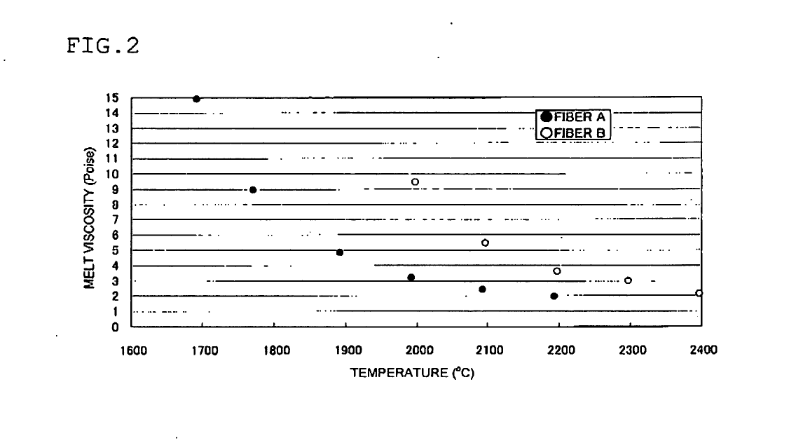

Raw materials for fibers A and B having a composition shown in Table 1 were heated and melted at 1700 to 2400° C. in a container by applying an electric power of 0.15 kW/kg to electrodes to obtain a melt having a melt viscosity of 1 to 15 poise. FIG. 2 illustrates the relationship between the melt viscosity of the fibers A and B and the temperature.

The resulting melt was supplied to a rotor rotating at an acceleration of 74, 115, or 259 km/s² via an orifice of the container at a speed of about 300 to 600 kg/h. The amount of the melt supplied was adjusted within a certain range using a control rod. Fibers were produced while blowing air around the rotors. FIG. 3 illustrates the relationship between the melt viscosity and the average diameter of the resulting fibers A and B.

The fibers A produced at a melt viscosity of 3 poise and an acceleration of 259 km/s² had a low flakes (shot) content of 40 to 50%.

The following measuring methods were used in the experiment.

### (1) Average Fiber Diameter

The fibers were observed and photographed using an scanning electron microscope. The diameter of 400 or more fibers photographed was measured, and the average value of all the measured diameters was taken as the average fiber diameter.

### (2) Shots

The fibers were rubbed on a sieve having a aperture size of 45 μm while sucking the fibers from the back surface of the sieve, and particles remaining on the sieve were determined to be shots.

### (3) Melt Viscosity

The melt viscosity was measured using a lifting sphere viscosimeter.

TABLE 1

| | | Fibers A | Fibers B |
|---|---|---|---|
| Fiber | SiO₂ | 73.1 | 76.2 |
| composition | CaO | 24.8 | 4.0 |
| (wt %) | MgO | 0.3 | 17.6 |
| | Al₂O₃ | 1.6 | 1.8 |
| | Fe₂O₃ | 0.2 | 0.2 |
| | K₂O | 0.0 | 0.2 |
| | Na₂O | 0.0 | 0.0 |
| | ZrO₂ | 0.0 | 0.0 |
| | P₂O₅ | 0.0 | 0.0 |
| | B₂O₃ | 0.0 | 0.0 |
| | La₂O₃ | 0.0 | 0.0 |

Note:
The unit of the composition is wt %.

### Experiment 2

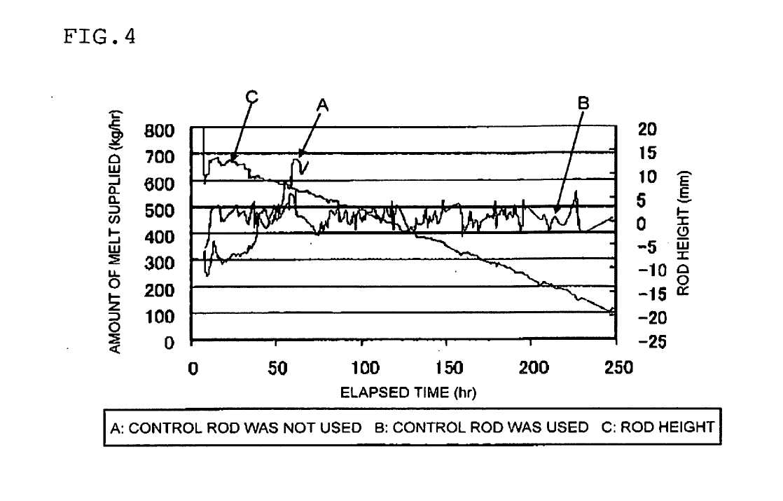

Fibers A were produced in the same manner as in Experiment 1 at a melt viscosity of 5 poise and an acceleration of 259 km/s¹. In Experiment 2, a change in the amount of the melt supplied to the rotor with time was measured with or without the control rod. The rod was lowered as the diameter of the hole of the orifice increased. The results are shown in FIG. 4 and Table 2. The height of the rod is also shown in FIG. 4. It was confirmed that a change in the amount of the melt supplied to the rotor could be suppressed by utilizing the rod, whereby the fiber diameter was reduced.

TABLE 2

| | Amount of melt | Standard | |
|---|---|---|---|
| | supplied | deviation | Fiber diameter |
| Rod was used | 340-550 | 36 | 3.5-3.9 |
| Rod was not used | 330-670 | 120 | 3.5-5.1 |

### Experiment 3

Fibers A were produced in the same manner as in Experiment 1 at a melt viscosity of 5 poise and an acceleration of 259 km/s². In Experiment 3, the supply temperature and the viscosity of the melt were measured while changing the power applied to the electrodes. The results are shown in Table 3.

TABLE 3

| | Fibers A | | Fibers B | |
|---|---|---|---|---|
| Applied | Supply | Melting | Supply | Melting |
| power | temperature | viscosity | temperature | viscosity |
| (kW/kg) | (° C.) | (poise) | (° C.) | (poise) |
| 0.10 | 1631 | 17.4 | 1877 | 14.0 |
| 0.15 | 1678 | 14.0 | 1919 | 11.8 |
| 0.20 | 1724 | 11.3 | 1961 | 9.9 |
| 0.25 | 1770 | 9.1 | 2003 | 8.4 |
| 0.50 | 2002 | 3.5 | 2213 | 3.8 |
| 0.60 | 2095 | 2.4 | 2297 | 2.9 |
| 0.70 | 2188 | 1.7 | 2381 | 2.2 |

Inorganic fibers produced by the method according to the invention can be used for various applications as a heat insulator or an alternative to asbestos, for example.

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

The documents described in the specification are incorporated herein by reference in their entirety.

1. A method of producing inorganic fibers comprising:
Heating and melting an inorganic raw material that comprises 70 wt % or more of silica and 10 wt % to 30 wt % of magnesia and calcia in total in a container to obtain a melt having a melt viscosity of 15 poise or less,
supplying the melt to a rotor that rotates at an acceleration of 70 km/s² or more,
drawing the melt due to a centrifugal force caused by rotation of the rotor to obtain fibers,
blowing the fibers off by blowing air around the rotor, and
collecting the fibers to obtain fibers having an average fiber diameter of 5 μm or less,
wherein the container has a hole for supplying the melt to the rotor at its bottom, a rod is provided inside the container toward the hole, and the amount of the melt supplied to the rotor is adjusted by bringing the rod close to the hole when the hole has increased in diameter, and
wherein the melt viscosity of the melt and the acceleration of the rotor satisfy the following expressions,
A≧36.81×P−11.21, and
15≧P
where, P is the melt viscosity (poise) of the melt, and A is the acceleration (km/s²) of the rotor.

2. The method according to claim 1, wherein the acceleration is about 100 km/s² or more.

3. (canceled)

4. The method according to claim 1, wherein the melt has a melt viscosity of about 7 poise or less, and is supplied to the rotor that rotates at an acceleration of about 259 km/s² or more.

5. (canceled)

6. The method according to claim 6, wherein the inorganic raw material is melted by applying about 0.15 kW/kg to about 0.70 kW/kg of electric power per unit raw material.

7. The method according to claim 6, wherein the inorganic raw material is melted by applying about 0.25 kW/kg to about 0.70 kW/kg of electric power per unit raw material.

8. (canceled)

9. The method according to claim 1, wherein the inorganic raw material is heated at about 1600° C. to about 2500° C.

10. The method according to claim 1, wherein the melt is supplied to the rotor at a speed of about 100 kg/h to about 1000 kg/h.

11. The method according to claim 10, wherein the melt is supplied to the rotor at a speed of about 250 kg/h to about 800 kg/h.

12. The method according to claim 1, wherein the fibers have an average fiber diameter of about 2 μm to about 4.4 μm.

13. The method according to claim 1, wherein the fibers comprise shots having a dimension of about 45 μm or more in an amount of about 65 wt % or less.

14. The method according to claim 1, wherein the fibers have the following composition 1 or 2,
<Composition 1>
SiO₂: about 70 wt % to about 82 wt %
CaO: about 1 wt % to about 9 wt %
MgO: about 10 wt % to about 29 wt %
AI₂O₃: less than about 3 wt %.
<Composition 2>
SiO₂: about 70 wt % to about 82 wt %
CaO: about 10 wt % to about 29 wt %
MgO: about 1 wt % or less
AI₂O₃: less than about 3 wt %.

15. The method according to claim 1, wherein the fibers comprise about 1.6 wt % to about 3 wt % of AI₂O₃.
